(19) United States
(12) Patent Application Publication
(10) Pub. No.: US 2010/0050445 A1
(43) Pub. Date: Mar. 4, 2010

(54) Structure of cutting edge of diamond blade

(76) Inventor: Fang-Chun Yu, Ying Ko Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,647

(22) Filed: Sep. 3, 2008

(51) Int. Cl. B23D 45/00

(52) U.S. Cl. 30/345

(57) ABSTRACT

An improved structure of a cutting edge of a diamond blade allows the cutting edge to be constantly sharp for cutting and have a long service life. The cutting edge is formed at an appropriate part of a particularly shaped metal shank or blank and is corrugated by stamping so as to form recesses on two sides of the cutting edge. The recesses of the cutting edge have inner bottoms whose depths are one-half or more than one-half a thickness of the metal shank or blank. The cutting edge can be further formed with plural openings. In addition, the two sides of the cutting edge have outer surfaces electroplated or coated with diamond particles, wherein a vertical distance between outermost portions of layers of the diamond particles formed respectively on the two sides of the cutting edge is greater than a thickness of the cutting edge.

### BACKGROUND OF THE INVENTION

1. Technical Field

The present invention relates to an improved structure of a cutting edge of a diamond blade, and more particularly, to an improved structure of a cutting edge of a diamond saw blade, a diamond saw wire and a diamond boring tube.

2. Description of Related Art

Diamond blades generally include diamond saw blades, diamond saw wires and diamond boring tubes. Referring to FIG. 1, a diamond blade typically has a cutting edge 101 formed at an appropriate part of a particularly shaped metal shank or blank 10. The cutting edge 101 has an outer surface electroplated or coated with diamond particles 102 to form an electroplated diamond blade or a coated diamond blade. Alternatively, the diamond particles 102 may be fixedly attached to the outer surface of the cutting edge 101 by brazing so as to form a metal bond single-layer diamond blade.

When the diamond blade is cutting an object, it is the diamond particles 102 fixedly attached to the outer surface of the cutting edge 101 that cut. Referring again to FIG. 1, when sharp tips of the diamond particles 102 fixedly attached to a forward end of the cutting edge 101 are worn and blunted, the cutting ability of the diamond blade is rapidly reduced, which directly lowers work efficiency. When the diamond particles 102 fixedly attached to the forward end of the cutting edge 101 are worn out or fall off entirely, slippage occurs between the bare metal forward end of the cutting edge 101 and the object being cut so that the diamond blade is no longer fit for cutting. This phenomenon is aggravated by a greater thickness of the cutting edge 101.

As described above, the aforesaid cutting edge structure has a limited service life. As soon as the single layer of the diamond particles 102 fixedly attached to the forward end of the cutting edge 101 is blunted or worn out, the edge 101 cannot cut.

The cutting edge 101 has a thick metal portion, whose thickness is greater than a combined thickness of layers of the diamond particles 102 formed respectively on two sides of the cutting edge 101. Therefore, when the diamond particles 102 on the forward end of the cutting edge 101 are worn out, the bare metal surface of the forward end of the cutting edge 101 cannot cut into but slip on the object to be cut. Meanwhile, the layers of the diamond particles 102 on the two sides of the cutting edge 101 provide little, if any, help in cutting.

### BRIEF SUMMARY OF THE INVENTION

In view that the shortcomings of the prior art require immediate improvement, the inventor of the present invention, based on years of experience in the related industry, strived to figure out ways to increase the service life and cutting efficiency of a diamond blade and, after repeated experiments and extensive research, finally succeeded in developing an improved structure of a cutting edge of a diamond blade characterized in that the cutting edge is constantly sharp for cutting as long as the cutting edge of the diamond blade exists.

The present invention provides an improved structure of a cutting edge of a diamond blade. More particularly, the present invention provides an improved cutting edge structure that is constantly sharp for cutting and has a long service life. The cutting edge is corrugated by stamping so as to form recesses on two sides of the cutting edge. In addition, the two sides of the cutting edge have outer surfaces electroplated or coated with diamond particles, wherein a vertical distance between outermost portions of layers of the diamond particles formed respectively on the two sides of the cutting edge is greater than a thickness of the cutting edge. When a forward end of the corrugated cutting edge is cutting an object, a corrugated metal main body of the cutting edge and part of the diamond particles will be worn. However, the remaining diamond particles are still available and sharp enough for cutting, so that the cutting edge is constantly sharp for cutting until the entire depth of the cutting edge is worn out.

### BRIEF DESCRIPTION OF THE SEVERAL VIEWS OF THE DRAWINGS

The objectives of the present invention as well as a preferred mode of use, the structure and the spirit of the invention can be understood by reference to the following detailed description of an illustrative embodiment when read in conjunction with the accompanying drawings, wherein:

FIG. 1 is a schematic cross-sectional view of a cutting edge of a conventional diamond blade, wherein sharp tips of diamond particles on a forward end of the cutting edge have been blunted;

FIG. 2 is a schematic cross-sectional view of the cutting edge of the conventional diamond blade, wherein the diamond particles on the forward end of the cutting edge have been worn out;

FIG. 3 is a schematic view of a metal blank of a diamond saw blade having an improved cutting edge structure of the present invention;

FIG. 4 is a schematic view of a metal blank of a diamond boring tube having the improved cutting edge structure of the present invention;

FIG. 5 is a schematic view of a metal shank of a diamond saw wire having the improved cutting edge structure of the present invention;

FIG. 6 is a schematic cross-sectional view of a cutting edge of a diamond blade according to the present invention, wherein recesses formed on the corrugated cutting edge have inner bottoms whose depths are more than one-half a thickness of a metal shank or blank of the cutting edge;

FIG. 6A is a schematic cross-sectional view of a cutting edge of a diamond blade according to the present invention, wherein recesses formed on the corrugated cutting edge have inner bottoms whose depths are one-half a thickness of a metal shank or blank of the cutting edge;

FIG. 6B is a schematic cross-sectional view of a cutting edge of a diamond blade according to another embodiment of the present invention, wherein the cutting edge is corrugated sinuously;

FIG. 7 is a schematic cross-sectional view of a cutting edge of a diamond blade according to yet another embodiment of the present invention, wherein the cutting edge is further provided with openings;

FIG. 7A is a schematic cross-sectional view of a cutting edge of a diamond blade according to the present invention, wherein a total thickness of the corrugated cutting edge is greater than a thickness of a metal shank or blank of the cutting edge;

FIG. 7B is a schematic cross-sectional view of a cutting edge of a diamond blade according to the present invention, wherein a total thickness of the corrugated cutting edge is smaller than a thickness of a metal shank or blank of the cutting edge;

FIG. 8 is a schematic cross-sectional view of a cutting edge of a diamond blade according to the present invention, wherein two sides of the cutting edge have outer surfaces electroplated or coated with diamond particles; and

FIG. 9 is a schematic drawing showing a cutting edge of a diamond blade according to the present invention cutting into an object.

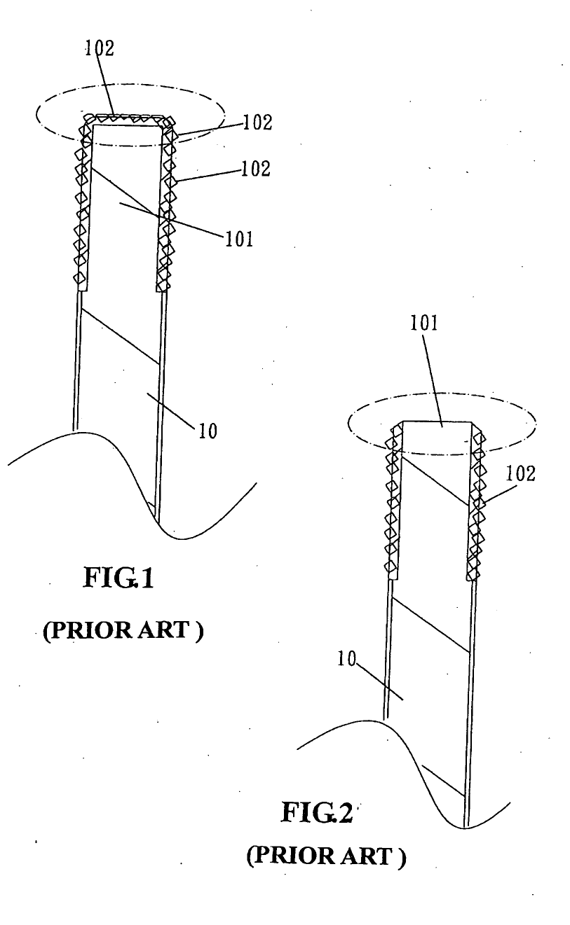

### DETAILED DESCRIPTION OF THE INVENTION

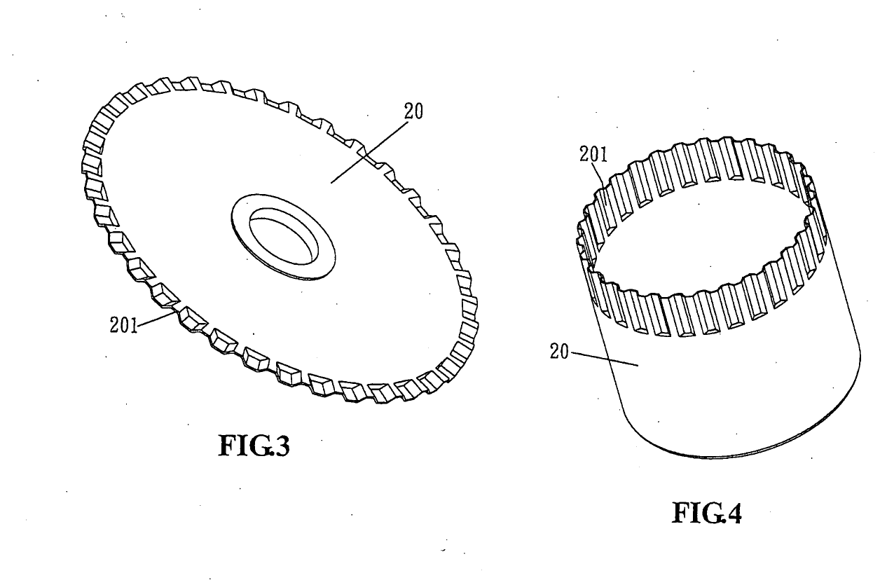

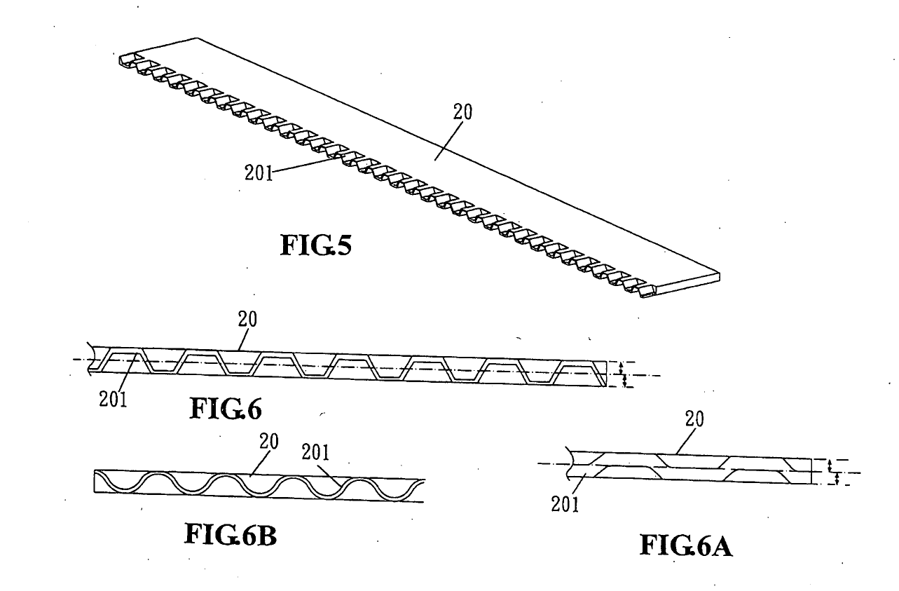

Referring to FIGS. 3 through 5, an improved structure of a cutting edge of a diamond blade according to the present invention comprises a cutting edge 201 formed at an appropriate part of a particularly shaped metal shank or blank 20, wherein the cutting edge 201 is corrugated by stamping so as to form recesses on two sides of the cutting edge 201. The recesses of the cutting edge 201 have inner bottoms whose depths are more than one-half (FIG. 6) or exactly one-half (FIG. 6A) a thickness of the metal shank or blank 20.

The metal shank or blank 20 is shaped according to the desired diamond blade to be made. For example, a diamond saw blade has a disk-like metal blank 20 (FIG. 3), a diamond saw wire has a strip-like metal shank 20 (FIG. 5) and a diamond boring tube has a tubular metal blank 20 (FIG. 4).

The cutting edge 201 according to the present invention can be corrugated angularly, as shown in FIG. 6, or sinuously, as shown in FIG. 6B.

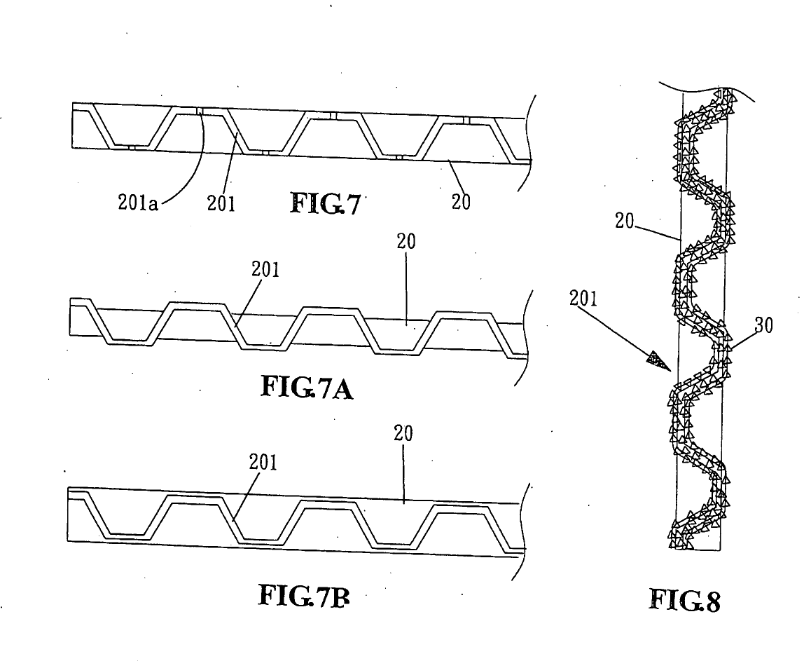

In addition, referring to FIG. 7, the cutting edge 201 according to the present invention may be formed with a plurality of openings 201a.

The corrugated cutting edge 201 according to the present invention may have a total thickness greater than (FIG. 7A), equal to (not shown) or smaller than (FIG. 7B) the thickness of the metal shank or blank 20.

As shown in FIG. 8, the two sides of the cutting edge 201 of the diamond blade have outer surfaces electroplated or coated with diamond particles 30. A vertical distance between outermost portions of layers of the diamond particles 30 formed respectively on the two sides of the cutting edge 201 is greater than a thickness of the cutting edge 201, so as to make the cutting edge 20 [symbol] [symbol] constantly sharp for cutting. Furthermore, the corrugated shape of the cutting edge 201 facilitates removal of swarf.

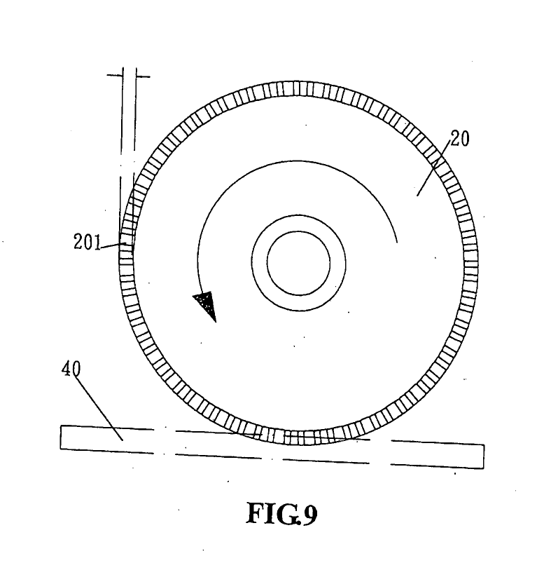

Referring now to FIG. 9, during cutting, a forward end of the corrugated cutting edge 201 cuts into an object 40. Since the cutting edge 201 and the layers of the diamond particles 30 electroplated or coated on the cutting edge 201 have corrugated shapes, there will always be sharp diamond particles available for cutting even when the forward end of the cutting edge 201 and the layers of the diamond particles 30 are partially or completely worn. In other words, until a metal main body of the cutting edge 201 and the layers of the diamond particles 30 are worn out, the cutting edge 201 is constantly sharp for cutting and therefore has a long service life.

As described above, the present invention is capable of achieving the intended effects and has not been seen in public use, thereby conforming to the patentability requirements of usefulness and non-obviousness. An application for patent of the present invention is therefore lawfully filed for examination.

The present invention has been described with reference to preferred embodiments thereof. All changes based on the present invention and having functions and effects that do not depart from the spirit of the present invention as disclosed in the specification and the accompanying drawings should be encompassed by the appended claims.

1. An improved structure of a cutting edge of a diamond blade, comprising the cutting edge formed at an appropriate part of a particularly shaped metal shank or blank and corrugated by stamping so as to form recesses on two sides of the cutting edge, characterized in that:
the recesses of the corrugated cutting edge have inner bottoms whose depths are more than one-half a thickness of the metal shank or blank; and
the two sides of the cutting edge have outer surfaces electroplated or coated with diamond particles, wherein a vertical distance between outermost portions of layers of the diamond particles formed respectively on the two sides of the cutting edge is greater than a thickness of the cutting edge.

2. The improved structure of the cutting edge of the diamond blade as claimed in claim 1, wherein the cutting edge is corrugated to facilitate removal of swarf.

3. The improved structure of the cutting edge of the diamond blade as claimed in claim 1, wherein the inner bottoms of the recesses of the corrugated cutting edge have depths one-half the thickness of the metal shank or blank.

4. The improved structure of the cutting edge of a diamond blade as claimed in claim 1, wherein the cutting edge is corrugated angularly or sinuously.

5. The improved structure of the cutting edge of the diamond blade as claimed in claim 1, wherein the cutting edge is further formed with a plurality of openings.

6. The improved structure of the cutting edge of the diamond blade as claimed in claim 1, wherein the corrugated cutting edge has a total thickness equal to the thickness of the metal shank or blank.

7. The improved structure of the cutting edge of the diamond blade as claimed in claim 1, wherein the corrugated cutting edge has a total thickness greater than the thickness of the metal shank or blank.

8. The improved structure of the cutting edge of the diamond blade as claimed in claim 1, wherein the corrugated cutting edge has a total thickness smaller than the thickness of the metal shank or blank.
